(19) United States
(12) Patent Application Publication
(10) Pub. No.: US 2025/0015654 A1
(43) Pub. Date: Jan. 9, 2025

(54) Motors and Related Methods of Manufacture and Use

(71) Applicant: Ye Olde Robotics Company LLC, San Francisco, CA (US)

(72) Inventors: Roy Benjamin Sandberg, San Francisco, CA (US); Dan Sandberg, Stockholm (SE)

(73) Assignee: Ye Olde Robotics Company LLC, San Francisco, CA (US)

(21) Appl. No.: 18/896,581

(22) Filed: Sep. 25, 2024

Related U.S. Application Data
(63) Continuation of application No. PCT/US23/16598, filed on Mar. 28, 2023.
(60) Provisional application No. 63/362,309, filed on Mar. 31, 2022.

(51) Int. Cl. H02K 1/2792; H02K 1/04; H02K 1/14; H02K 9/06; H02K 11/33; H02K 15/03; H02K 21/22

(52) U.S. Cl. CPC H02K 1/2792; H02K 1/04; H02K 1/146; H02K 9/06; H02K 11/33; H02K 15/03; H02K 21/22; H02K 2211/03

(57) ABSTRACT

Motors disclosed herein may include a stator comprising electrical windings thereon. A stator housing at least partially houses the stator. A rotor assembly is rotatingly coupled with the stator housing and includes a rotor, which may be formed of a polymer, and a plurality of magnets coupled with the rotor. In implementations the magnets are coupled with the rotor using a friction fit or one or more snap locks, and/or without the use of glue. In implementations the rotor assembly excludes a back-iron. In implementations the stator housing is formed of a polymer. Methods of formation of a rotor are disclosed, including methods of inserting one or more magnets into slots within the rotor, including at varying angles of rotation. In implementations the magnets are organized into a Halbach array.

### CROSS REFERENCE TO RELATED APPLICATIONS

This document is a bypass continuation application of PCT App. No. PCT/US23/16598, entitled “Motors and Related Methods of Manufacture and Use,” naming as first inventor Roy Sandberg, which was filed on Mar. 28, 2023 and which has an international filing date of Mar. 31, 2022, which PCT application claims the benefit of the filing date of U.S. Provisional Patent Application No. 63/362,309, entitled “Plastic Rotor Halbach Array Motor Machine and Method for Manufacture,” naming as first inventor Roy Sandberg, which was filed on Mar. 31, 2022, the disclosures of which are hereby incorporated entirely herein by reference.

### BACKGROUND

### 1. Technical Field

Aspects of this document relate generally to motors and related methods of manufacture and use. Specific aspects of this document relate to brushless direct current (BLDC) motors using Halbach arrays.

### 2. Background Art

Brushless direct current (BLDC) electric motors are traditionally manufactured primarily from various metals such as steel, copper, and aluminum. While plastic may be used in small quantities for motor components such as insulating barriers, fan blades, and electrical connector housings, they are generally not used for the rotor because a magnetic path is needed for greater efficiency in the magnet circuit. This is generally supplied by what is known in the art as a back-iron. A back-iron is a ferromagnetic ring onto which the magnet structure is attached, typically using industrial adhesives, or a cylinder around the magnets, that forms the return path of flux between adjacent magnets within the rotor. However, back-irons tend to be heavy, increasing the inertial moment of the rotor, and the adhesive process is messy, complex, and prone to misalignment.

BLDC motors generally require external commutation. In particular, a micro-controller is typically used to determine the location of the rotor, and an appropriate magnetic field is generated in the stator to motivate the rotor to spin at the desired speed and direction. Sensored commutation is often accomplished with Hall effect sensors (hereinafter Hall sensors). Typically, three sensors are used, spaced 60 or 120 electrical degrees apart, as is known to one skilled in the art. The sensors measure the magnetic field and digitally trigger when the field passes a threshold. This allows the rotor location to be known to the micro-controller, and thus the stator can be appropriately energized. Sensor-less commutation is done by measuring the counter-electromotive force (counter EMF or back EMF) to determine the location of the rotor magnets relative to the stator. In both cases, slow speed operation of the motor is difficult and imperfect. Sensor-less commutation requires sufficient motor speed to produce measurable back EMF, and thus slow speed operation is difficult to accurately control. Digital Hall sensors only trigger at particular points in the motor's rotation, and so intermediate positions must be interpolated, which limits the accuracy of this control technique at slow speeds, particularly when the force applied by the load changes. In both cases, slow speed control of motors is generally accomplished using external encoders that can more accurately measure the position of the motor, but with added complexity and cost.

Typically, a BLDC motor is controlled using external commutation which requires a separate controller. These controllers must be configured to match the parameters of the motor being controlled, said parameters including motor pole count, motor winding resistance, motor winding inductance, motor rotor inertia, and motor rotational friction. Thus, configuring a BLDC motor for use with a BLDC motor controller is a non-trivial endeavor.

### SUMMARY

Disclosed herein are motors and related methods for manufacture and use thereof utilizing a polymer rotor (which may by non-limiting example be formed of plastic) to contain the magnet structure without the use of adhesives. A magnetic arrangement known as a Halbach array is used to eliminate the need for a back-iron, and a method for manufacture is introduced that reduces the difficulty in manufacturing a Halbach array.

Further described herein is a means of using two analog Hall sensors to accurately determine the position of the motor. While there exist latching (or digital) Hall sensors, which only have two states, in implementations the motors and related systems and methods herein use analog Hall sensors to accurately track position.

Further described herein is a means of integrating a motor controller and motor driver into the motor itself, allowing a simplified, preconfigured and integrated design to be offered to end users. Additionally, this design reduces the cost of manufacture by eliminating the need for an additional enclosure, connectors, and wires.

Through the use of analog Hall sensors rather than the traditional digital latching Hall sensors typically used in the art, accurate rotation at low speeds becomes possible.

The analog Hall sensors are also used as the basis of an anti-cogging algorithm that feeds forward motor currents based on a knowledge of the rotor position, and with a magnitude such that cogging torque is canceled. The relationship between rotor position and cogging torque is established during motor production, such that the end user is not required to calibrate the motor to enable the anti-cogging capability. This ensures smooth low speed motion.

An integrated fan is utilized to cool both the printed circuit board (PCB) and the motor windings, allowing the motor to operate at higher currents than would ordinarily be possible, even at low speeds.

A through hole is included for simplified wiring and other uses such as routing air for vacuum or cooling and as a means to provide various inserts such as axles and lead screw nuts.

General details of the above-described implementations, and other implementations, are given below in the DESCRIPTION, the DRAWINGS, the CLAIMS and the ABSTRACT.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1A shows a front, side, exploded view of an example fanless motor;

FIG. 1B shows a front, side, exploded view of an example motor with a fan;

FIG. 2A representatively illustrates example magnet orientations of a portion of a Halbach array;

FIG. 2B representatively illustrates magnets and magnetic field lines of a Halbach array;

FIG. 3A shows a rear, side view of an example polymer rotor;

FIG. 3B shows a rear, side view of an example polymer rotor;

FIG. 4A shows a rear, side, top view of an example magnet insertion machine used to insert magnets into a rotor;

FIG. 4B shows a rear, side, top view of an example magnet insertion machine used to insert magnets into a rotor;

FIG. 5A shows a top view of an example magnet insertion machine used to insert magnets into a rotor;

FIG. 5B shows a side view of the example magnet insertion machine of FIG. 5A;

FIG. 6A shows a front view of the example fanless motor and fan of FIG. 1B;

FIG. 6B shows a top cross-section view of a portion of the example fanless motor and fan of FIG. 6A taken along the cross-section lines shown in FIG. 6A;

FIG. 7A shows a front, side view of elements of an example motor;

FIG. 7B shows representatively illustrates elements of an example motor and related magnetic field lines;

FIG. 8 is a front view of an example stator and windings of a motor, illustrating an example winding pattern;

FIG. 9 is a block diagram representatively illustrating example elements of control of a motor;

FIG. 10 representatively illustrates example anti-cogging elements of a motor;

FIG. 11 representatively illustrates an example motor network;

FIG. 12 shows a rear, side, exploded view of example elements of a motor; and

FIG. 13 representatively illustrates a rear, side view of an example stator and printed circuit board (PCB) assembly of a motor.

### DESCRIPTION

Implementations/embodiments disclosed herein (including those not expressly discussed in detail) are not limited to the particular components or procedures described herein. Additional or alternative components, assembly procedures, and/or methods of use consistent with the intended motors and related methods of manufacture and use may be utilized in any implementation. This may include any materials, components, sub-components, methods, sub-methods, steps, and so forth.

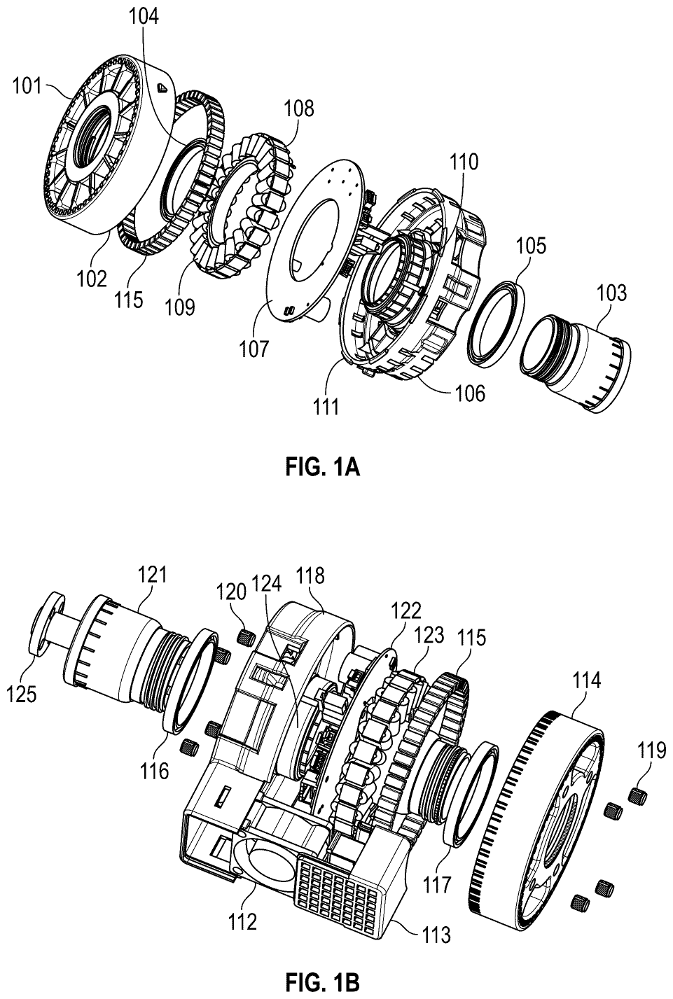

Referring now to FIG. 1A, an exploded diagram of a fanless motor is shown. The fanless variant of the motor comprises a rotor assembly (which includes a rotor 101 and magnets inserted into the rotor's magnet slots 102, which may also be referred to as cavities), and an axle 103, all rotatably attached via a pair of ball bearings assemblies 104, 105, to a stator retainer housing 106.

The stator housing 106 retains a printed circuit board (PCB) assembly 107 and a stator 108 with windings 109 (which are shown in FIG. 1A in a simplified format, but stator windings are known in the art so that further illustration is not necessary) which correlate with a central keyed column 110. Captive nuts (hidden) affix the stator housing to an external attachment point. The stator housing includes flanges 111 along the circumference to allow an external fan adapter, cover, or external encoder to be fitted to the rotor side of the motor.

Referring now to FIG. 1B, an exploded diagram of a motor with a fan is shown. The motor with fan has largely the same construction as the fanless motor, with the addition of a small fan 112 contained at least partially within a rectangular enclosure 113 of the stator housing 118. As with the fanless variant, the design comprises a rotor assembly (including rotor 114 and magnets 115 arranged in a Halbach configuration) and axle 121 rotatably attached via ball bearing assemblies 116, 117, to the stator housing. Threaded inserts 119, 120 allow mechanical connection to the rotor and stator housing, respectively. These inserts are for connecting the motor to its attachment point, and for connecting a rotating load to the motor. In implementations the threaded inserts are internally threaded metal columns that are inserted into plastic (e.g., by heating or using ultrasonics or heat staking) so that the threaded insert, now secured within the plastic, can accept a threaded retainer such as a screw or bolt. Threads formed directly in plastic with a pitch/size that matches the pitch/size of a metal screw may not have sufficient torque-out capacity to survive some use cases, thus the inserts are used. Examples of heat staking for internally threaded inserts are given in “Secondary Operations: Heat Staking,” published online by the B.E.C. Group at https://www.becgroup.com/news/spotlight-on-secondary-operations-heat-staking/at least as early as Sep. 26, 2021, the disclosure of which is entirely incorporated herein by reference. Axle 121 threads into the rotor assembly, allowing preload on the bearings to be adjusted. The PCB assembly 122 and wound stator 123 (showing simplified windings as with FIG. 1A) stack onto the stator housing central keyed column 124. A lead screw nut 125 (which in implementations is brass) is inserted into the axle, although other configurations (and other materials) are also possible. In implementations the fan enclosure snaps into the stator housing using a cantilevered snap lock.

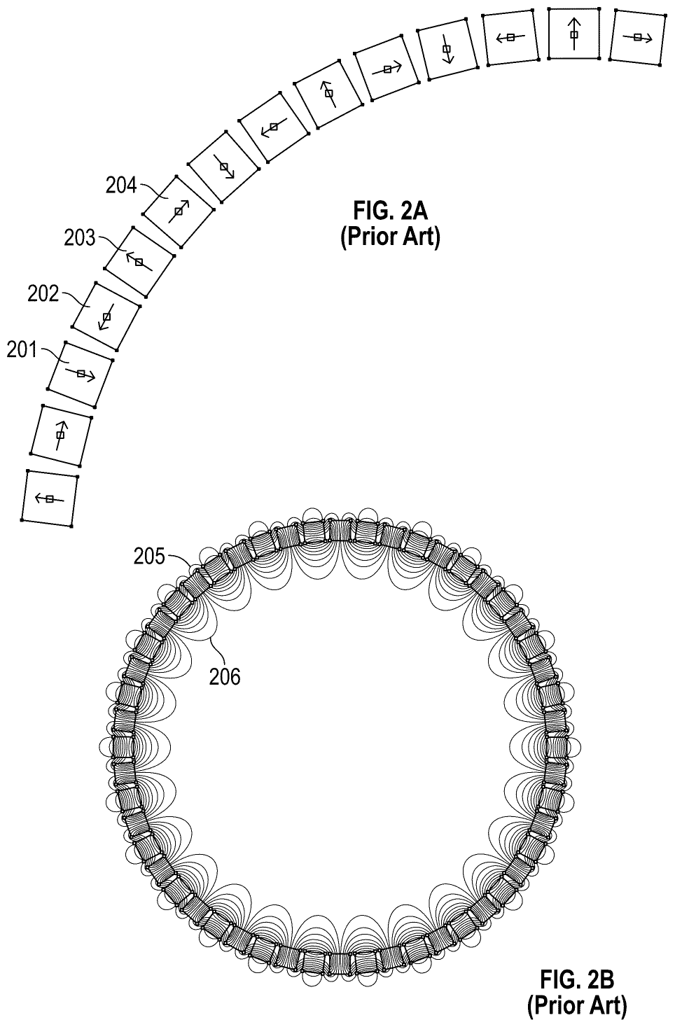

Referring now to FIGS. 2A and 2B, elements of a prior art Halbach array arrangement are illustrated. An arrangement of magnets known as a Halbach array is used herein to eliminate the need for a back-iron, and to allow an all-polymer rotor to be used. In a Halbach array, the magnets are arranged with their fields oriented at 90 degrees of angular difference with respect to adjacent magnets. FIG. 2A shows the arrangement and orientation of the magnets for a section of a complete Halbach ring, including magnets 201, 202, 203, and 204 which representatively illustrate four 90-degree angular differences. As representatively illustrated in FIG. 2B, for a complete ring 205 with this sequence of magnet orientations the resulting magnetic field lines 206 are predominantly on the inside face of the rotor rather than on the outside face. This amplifies the magnetic field on the side of the magnet ring that faces the stator, and attenuates the magnetic field on the side that does not interact with the stator.

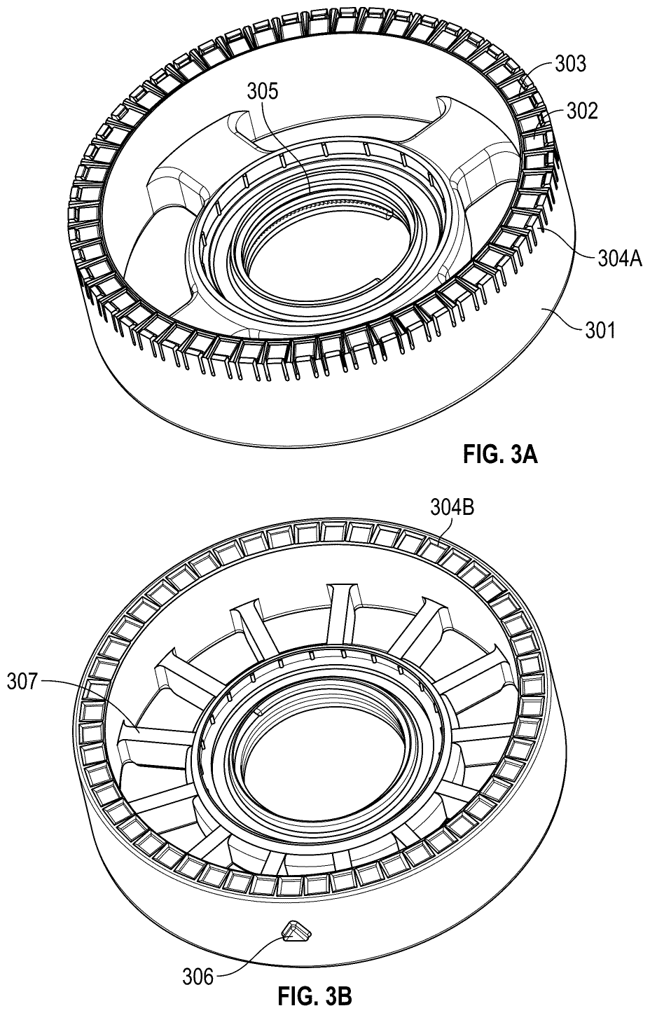

Referring now to FIG. 3A, a conformal polymer rotor 301 is shown. The rotor in this example is formed of plastic. The rotor is coupled with fifty-two magnets 302 arranged in a Halbach configuration. Each magnet retention slot 303 includes a cantilevered snap lock 304A that retains the magnet without the need for adhesive. A threaded axle retainer 305 provides a means of attaching the axle. In the alternative, a snap-fit or adhesive may be used to affix the axle to the rotor.

Referring now to FIG. 3B, in an alternative embodiment of a conformal polymer rotor (which in the example is formed of plastic), instead of cantilevered snap locks 304A an annular snap lock mechanism 304B could be used, wherein the magnet slot entrance is slightly smaller than the magnet, and deforms to accommodate it as it is inserted. It should be understood that the entrance to each slot is only temporarily deformed, and returns to its original size after the magnet is inserted far enough within the slot to move past the entrance.

The rotor may include an alignment mark 306, to provide for manual alignment of the rotor during calibration or for other uses. Cooling fins 307 (which may be hollow) may be utilized to provide airflow to the stator winding while the motor is in motion.

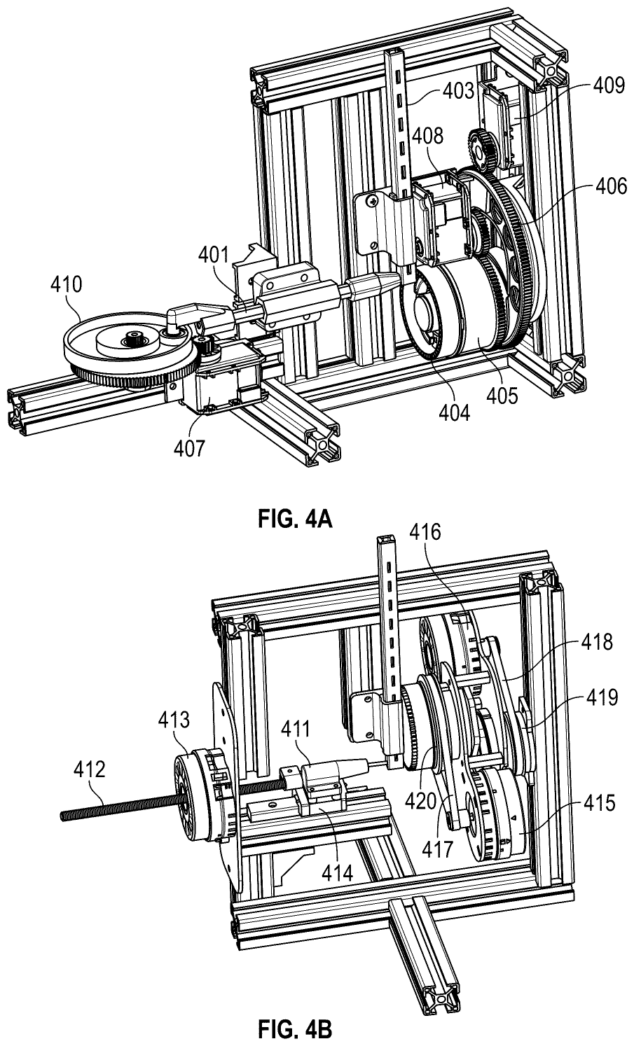

Referring now to FIG. 4A, one or more steps of an example rotor manufacturing technique are illustrated. A shown magnet insertion machine has three motion axes. The linear plunger 401 is a magnet inserter and corresponds with a first linear axis to push a magnet out of the magnet cartridge 403 to insert it into one of the rotor's magnet retention slots 404. The rotator 405 corresponds with a second rotational axis and rotates the rotor such that every fourth magnet retention slot aligns with the linear plunger. In this way all magnets with the same magnetic alignment are first inserted into the rotor. Rotator 406 corresponds with a second rotational axis and rotates the entire rotor axis assembly such that the magnets may be inserted in any of four ninety-degree offset alignments. Three servos control the three motion axes. The linear motion servo 407 drives the linear motion cam 410 using a geared interface. The linear motion cam in turn induces linear motion of the linear plunger. Other means of inducing linear motion, such as lead screws, belt drives, or other motion control techniques known in the art may also be used to move the linear plunger. The rotor axis servo 408 rotates rotator 405 using a geared interface. Other means of inducing rotary motion such as direct drive, belt drives, or other motion control techniques known in the art may also be used to induce rotary motion of the rotor axis. The rotor alignment servo 409 rotates the rotator 406 via a geared interface. Other means of inducing rotary motion such as direct drive, belt drives, or other motion control techniques known in the art may also be used to induce rotary motion of the rotor alignment axis. Although there is only one linear plunger in the shown example, in other implementations there could be multiple linear plungers simultaneously inserting magnets into different slots (for example using multiple cartridges), such as to speed up the insertion process.

The servos may be programmed to insert an arbitrary number of magnets, in sets of four. Each set of four represents one pole pair. For a rotor with thirteen pole pairs, the following exemplary control sequence could be used: thirteen magnets are inserted into every fourth slot by first inserting the plunger into the slot, removing the plunger, and then rotating the rotor one-thirteenth of a full rotation. This process is repeated thirteen times for each of the thirteen first magnets. The rotor alignment axis is then rotated ninety degrees such that the magnet slots on the rotor are also rotated ninety degrees with respect to the magnets inside the magnet cartridge. The rotor is then advanced one slot, or 1/52th of a full rotation, such that the next thirteen magnets may be inserted, each adjacent to the first thirteen magnets. This process continues until all fifty-two magnets (or thirteen pole pairs) are inserted into the rotor.

An alternative embodiment of the magnet insertion machine is shown in FIG. 4B. This embodiment uses example motors disclosed herein as the servos themselves to insert the magnets into a new motor. It can be seen that the linear plunger 411 in this embodiment includes a leadscrew 412 that is driven by a motor 413 (the motor drives the leadscrew using a leadscrew nut insert). The leadscrew is stabilized by a linear rail assembly 414. This advantageously allows for more torque to insert the magnets into the rotor magnet slots. A rotor servo 415 is used to shuttle between magnet slot positions and a rotor alignment servo 416 is used to rotate the rotor to one of four ninety-degree offset orientations to provide for the correct or desired Halbach array angles. The rotor servo and the rotor alignment servo drive toothed belts 417 and 418, respectively. Toothed belt 418 couples with a fixed pulley 419 (which may in implementations be toothed) which is in turn coupled with a frame of the machine, such that when the rotor alignment servo rotates, it causes the entire assembly comprising the rotor alignment servo, the rotor servo, and the rotor itself to swivel about the fixed pulley as one unit. Toothed belt 417 couples with a toothed pulley 420 that the rotor (which is being populated with magnets) is threaded onto using its threaded interior section.

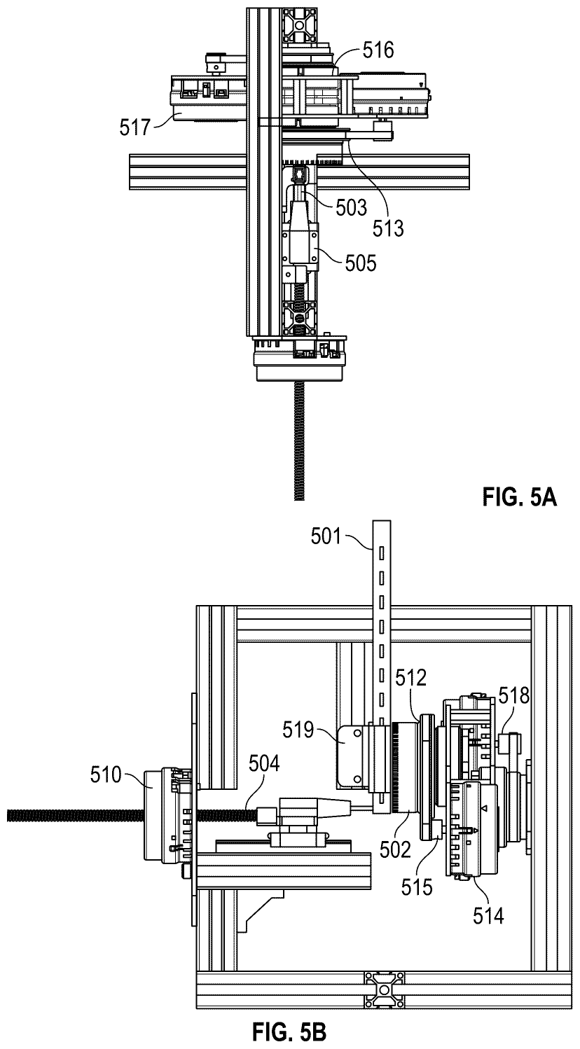

FIG. 5A representatively illustrates a top view of a magnet insertion machine and FIG. 5B illustrates a side view of the same magnet insertion machine. The magnet insertion machine inserts magnets into the rotor in the correct or desired orientation such that a Halbach array is created. The magnet insertion machine includes a linear axis that pushes magnets that have been stacked within a magnet cartridge 501 into slots within a polymer (in this case plastic) rotor 502. All magnets are stacked in the same magnetic orientation within the cartridge. A plunger 503 at the tip of the linear axis pushes the magnets out of the cartridge and into the rotor. A leadscrew 504 is coupled with, and moves along, a linear stage 505 to provide linear motion to the plunger. The leadscrew is driven by a servo 510 with a central through-hole and an integrated leadscrew nut.

The rotor inserts into a rotor holder 512 which includes an integrated pulley 513 and is driven by a servo 514 using a toothed pulley 515 and a belt. In this manner, the rotor is made to rotate such that the plunger can insert a magnet into any of the rotor's magnet slots.

The magnets may be inserted in any of four orientations, each ninety degrees apart. Altering the orientation of the magnets by ninety degrees within each adjacent slot is done to construct a Halbach array. These differing orientations are providing using magnet rotation platform 516. The magnet rotation platform is centered about a magnet slot of the rotor. In this way, the magnet rotation slot may be rotated in place while always maintaining linear alignment between the plunger and a magnet slot. Naturally, this works partly because the magnets and the magnet slots each have a square cross-section such that the magnets can be inserted into the slots regardless of the specific rotation. The magnet rotation platform is made to rotate using a stationary toothed belt pulley that is driven by a servo 517 with a toothed drive pulley 518 using a belt.

The magnet cartridge is tall enough to store at least enough magnets to insert all the magnets required to build a complete circular Halbach array. The magnet cartridge can be removed from a cartridge holder 519 to allow easy refilling. Additionally, this allows visual alignment of the plunger with the rotor's magnet slots by sliding the magnet cartridge up and then extending the plunger such that the cartridge then rests upon the upper surface of the plunger. The plunger can then be carefully visually aligned with a particular magnet slot in the rotor, and when the plunger's motion sequence begins, and it initially moves away from the rotor's magnet slot, the cartridge will drop into place, allowing subsequent plunger motion towards the magnet slots to insert magnets. This is due in part to the fact that the cartridge includes a stop that rests atop a cartridge holder, such that when the plunger's motion sequence begins and the plunger retracts, the cartridge (which had been resting atop the plunger) falls by gravity and stops at the appropriate position due to the stop, and the forward plunger motion then inserts a magnet. Note that this alignment may not be needed, in some instances, and in some cases it may be done only for the first magnet (to ensure alignment between the plunger and the first slot), with all remaining magnets being inserted without needing any further alignment—or in some implementations multiple alignment steps may be done. In other implementations the system may be configured for automatic alignment such as using visual or other sensors and alignment motors or the like.

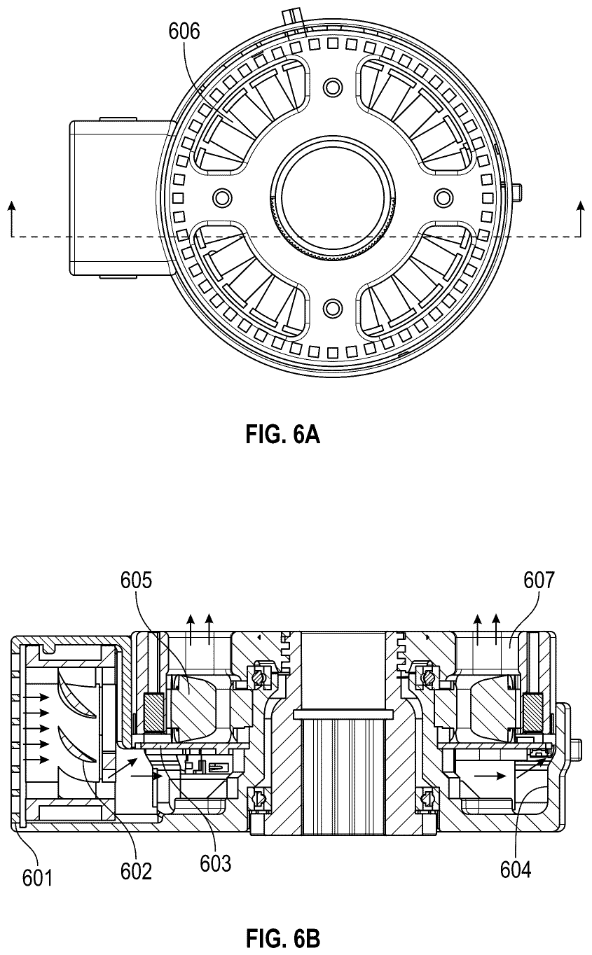

FIGS. 6A and 6B representatively illustrate airflow using the fan. The fan may be used to cool both the PCB assembly (PCB) and the stator windings. Air enters through the fan grate 601 of the enclosure 113 (seen in FIG. 1B), and then flows through the fan 602 (which may be similar or identical to fan 112), where it is then directed to the top surface of the PCB 603 (which may be similar or identical to PCB assembly 122)—it is pointed out that the top surface of PCB 603 faces downward in FIG. 6B. The air cools the PCB and flows through a space between the outer diameter of the PCB and the inner diameter of the stator housing 604 (which may be similar or identical to stator housing 118 and which may be formed of a polymer, including a plastic). The air then flows across a portion of the bottom surface of the PCB (i.e., the surface opposite most or all of the PCB's electronic components, which in FIG. 6B faces upwards), and then it is directed across the stator windings (i.e., between the stator windings) in area 606, to cool the stator windings and the stator, and the air then escapes through the rotor vent holes 607. In this way, both sides of the PCB and the stator are kept cool using a single source of airflow and despite the poor thermal dissipation of a polymer or plastic stator housing. Additionally, the airflow is directed across the desired surfaces by integrated duct work, and so unlike a conventional external fan (or passive cooling), the cooler air is directed precisely to the locations in need of cooling, resulting in improved heat dissipation. Additionally, unlike a motor with fan blades integrated on the rotating shaft, this design cools the motor even under stall and low speed operation.

The fan may be always on, or the fan may be activated when more cooling is needed. In the ideal embodiment, a temperature sensor is integrated onto the PCB, and a thermal conductor is placed between the temperature sensor and the stator windings. The temperature sensor communicates with the micro-controller on the PCB to allow the motor controller to determine the temperature of the windings. The temperature sensor may be integrated into the micro-controller itself. The thermal conductor may be an adhesive thermal pad placed on the underside of the PCB (i.e., the side opposite most or all of the PCB's electronic components), such that heat from the windings is substantially routed from the windings, through the thermal pad, through the PCB, and into the micro-controller on the top surface of the PCB (i.e., the surface of the PCB with most or all of the electric components).

The temperature sensor data may be used to control the fan activation or fan speed. The temperature sensor data may also be used to prevent the stator windings from overheating, such as by limiting current flow to the stator windings. Current flow to the windings may also be limited in conjunction with (or after) modeling heat generated by the windings due to instantaneous current flow through the windings (without real-time temperature sensor data) and limiting the current flow based on that model.

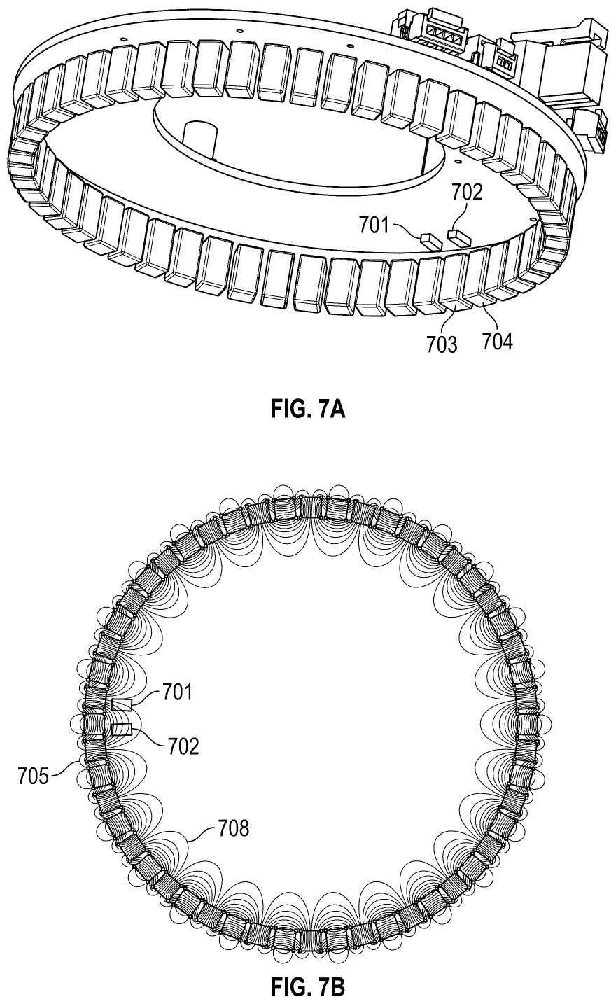

FIGS. 7A and 7B representatively illustrate Hall sensor and rotor position details. Two analog Hall sensors 701, 702 are mounted on the PCB such that they are close enough to the magnets 703, 704 (which may be similar or identical to magnets 115) contained within the rotor to sense the magnetic field (representatively illustrated by magnetic field lines 705 and 708) generated by the magnets. The magnetic field lines 708 generated by the rotor assembly are roughly sinusoidal in nature, with one complete sinusoid generated each time a pole pair moves past a Hall sensor. The Hall sensors 701, 702 are placed ninety electrical degrees apart from each other from the perspective of the field lines. In other words, if the motor has thirteen pole pairs, and each pole pair represents a complete sinusoid, then the Hall sensors are positioned such that the angle between them (relative to the center of the motor) is 1/52 of a full circle. This simplifies the conversion from field strength to angle because, when placed ninety degrees apart from the perspective of the field, the two sensors output sine and cosine, respectively (cosine is simply sine shifted by ninety degrees). Thus, the angle swept by a pole can be calculated by computing the arc-tangent of sine over cosine.

This angle is used both to compute the motor's position, and also for the field oriented control (FOC) algorithm that is used to control the voltages that are applied to the motor's three phases.

While the field lines generated by the rotor assembly are roughly sinusoidal, they are not precisely sinusoidal, owing to difference between the strengths of adjacent magnets, spacing between the magnets, and other construction artifacts. In implementations these non-linearities are corrected for programmatically via a calibration step during the manufacturing process. By rotating the motor through a full three-hundred sixty degrees, and comparing the values registered on the Hall sensors to a highly accurate external encoder, deviations from the true linear positions can be determined and compensated for. A mapping from actual 2-argument arctangent (atan 2) output values to corrected (linearized) values can be built by relating the atan 2 output values to the values registered by the accurate external encoder. This information can be used to build a linearization data structure. Specifically, the atan 2 transition from high to low (or low to high) allows the software to determine when the rotor has moved from one pole to the next. An initial alignment step may be used to allow the motor to determine which pole is currently generating the atan 2 output value. For each pole, linearization may be accomplished by means known in the art, or by the method described herein. The method includes fitting a series of linear segments to each atan 2 pole segment. For example, sixty-four linear segments may be fit to the linear segment output for a particular atan 2 pole output. By using a number of linear segments that is a power of 2 (2\hat{ }n), the first few bits of the atan 2 output value can be used to quickly determine the correct line segment to use to linearize the value returned by the atan 2 result. By storing a slope and offset for each line segment, a mapping can be made from atan 2 values to corrected (linearized) values. In an alternative embodiment, a spline or other non-linear polynomial or other function may be used to map the atan 2 output to a linearized result. In addition to the per-pole linearization data, an overall average of motor poles may be used to linearize the atan 2 output in the event that the current motor pole is not known.

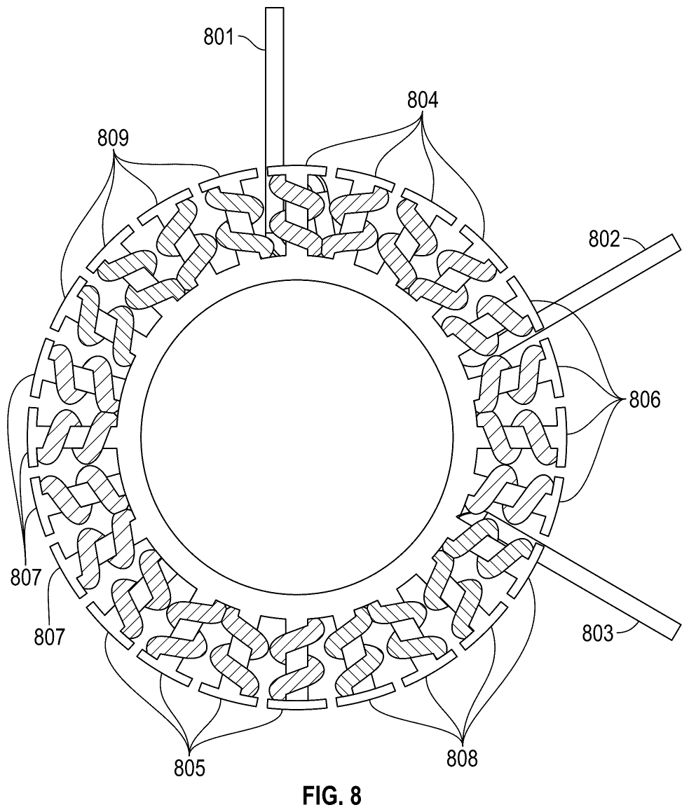

FIG. 8 representatively illustrates an example winding. The stator of FIG. 8 is wound using a wild wound fly winding technique. A distributed Lucas, Retzbach and Kühfuss (dLRK) winding pattern is used. FIG. 8 representatively illustrates this winding configuration for a motor with 24 slots. As can be seen, each of the three phases (A, B, and C), beginning at the shown start locations 801, 802, 803, are wound in opposite directions for adjacent pole sets 804, 806, 808 (each set consisting of four poles), and mirrored on the opposite pole sets 805, 807, 809 across the center of the stator. Thus there are three sets of eight poles wound on the motor, with eight poles for each phase. In implementations the stator windings are all electrically connected at their end points. This is known as a Y winding. In implementations the three start points and ending points all directly connect electrically to the PCB, minimizing the need for connectors and minimizing unnecessary ohmic losses due to connective wiring. This winding pattern results in cogging torque equal to the least common multiple of the slot count and magnet pole count. In this case, that equates to three-hundred twelve cogging steps. Starting at the top central pole, and where a lower case letter refers to a counter-clockwise winding direction and a capital letter refers to a clockwise winding direction, and where the letters themselves refer to one of the three electrical phases, the shown embodiment uses a winding pattern of AaAabBbBCcCcaAaABbBbcCcC.

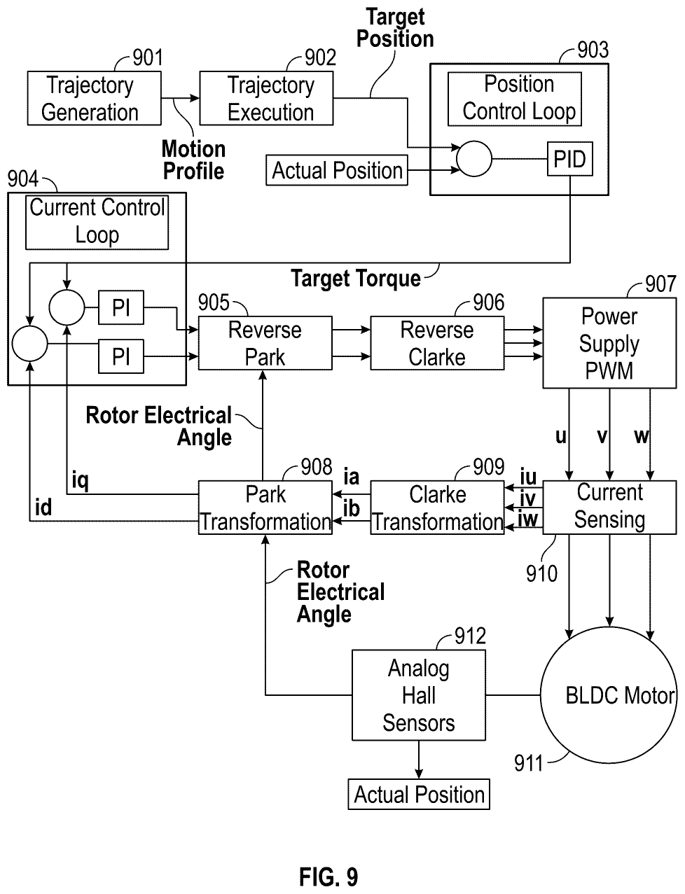

FIG. 9 is a block diagram representatively illustrating example elements of control of a motor. In implementations the motor is controlled using an embedded micro-controller running an algorithm that both controls the current sent to the three phase windings and controls the position, velocity, acceleration, and jerk of the motor. The algorithm may begin by building a trajectory (trajectory generation) 901 based on user requirements. These requirements may be communicated to the micro-controller from an external source over a communications network such as through a wired or wireless connection, including using an RS-232, RS-485, CAN, Ethernet, BLUETOOTH, or WiFi connection, or any other connection. In the alternative, trajectories may be preloaded onto the motor for subsequent use upon an external trigger such as an interrupt line, analog voltage level, or a switch changing state. A trajectory may involve moving from one position to another with a specified acceleration, deceleration, jerk, and velocity. In implementations a trapezoidal motion profile may be used, or an s-curve motion profile may be used. In the alternative, an asymmetric jerk-constrained motion profile may be used, such as the one discussed in the paper “A jerk-constrained asymmetric motion profile for high-speed motion stages to reduce residual vibration” by Huaizhong Li, published online Feb. 1, 2016 in International Journal of Computer Applications in Technology, Vol. 53, No. 2, the disclosure of which is entirely incorporated herein by reference. Other motion profiles known in the art may also be generated for use by the motor. Spline motion between a series of points sent over the communications network may also be used as the motion profile. In another modality, the motor may be commanded to move at a particular velocity, with a specified acceleration and jerk used to reach that velocity. In this case, the motor would continue spinning at the specified velocity for a specified time or until a stop motion command was issued.

Once a trajectory has been generated, it can be executed (trajectory execution) 902. The trajectory may be broken into a series of target positions, such that each of the series of target positions is sent to the position control loop 903 as a new target position in an evenly time-spaced sequence. For example, a new position from the generated trajectory may be loaded into the position control loop every millisecond. In this way the position control smoothly iterates through all the generated positions, resulting in a smooth and continuous motion profile.

The position control loop 903 may include a proportional-integral-derivative (PID) control loop that attempts to minimize the error between the current target position and the actual position of the motor as measured by the analog Hall sensors. In an alternative embodiment, an external position sensor may be used. This external position sensor may be mounted on the output shaft of a gear reducer as one example, to minimize the error between the measured position and the load being used. The external position sensor may be a dual quadrature encoder, an inductive encoder, or another position sensor type known in the art. The error term calculated by the position control PID loop may be fed to the current control loop 904 as the target torque. In an alternative embodiment, a velocity control loop may be placed between the position control loop and the current control loop, as is known in the art.

The current control loop 904 is a component of the field oriented control algorithm that is used to control the phase winding currents. As is known in the art, the field oriented control method breaks the winding current into two components: the flux current and the torque current. The flux current represents the flux that is perpendicular to the magnets and the phase windings (in other words, the current that does not generate torque). The goal is to minimize the flux current (in other words, keep it at or near zero) and force the torque current towards the target torque. In this way, motor performance can be maximized. This goal is accomplished using two independent proportional-integral (PI) control loops, one for the flux current and the other for the torque current. The inputs to the two control loops are the target torque current, the target flux current (i.e., zero), the actual torque current, and the actual flux current. The actual torque current and the actual flux current may be calculated at a current-sensing step 910 using a process that will be discussed below. The output of the two control loops are the desired flux and torque voltages, which are used as the input to the reverse Park transformation step 905.

The reverse Park transformation 905 takes a desired flux and torque voltage and converts from a rotating reference frame to a stationary reference frame, as is known in the art. These values are then forwarded to the reverse Clarke transformation step 906.

The reverse Clarke transformation step 906 takes the stationary frame flux voltage and stationary frame torque voltage and converts them into the three phase winding voltages, as is known in the art. These three values are then forwarded to the power supply pulse-width modulation (PWM) step 907.

The power supply PWM step 907 takes the rail voltage supplied by the power supply and switches it on-and-off at high speed using the pulse-width modulated technique that is known in the art. Each of the three motor phases is pulse-width modulated to the desired voltage. For example, if the rail voltage is twenty-four volts, and the voltage to the U phase is rapidly switched on and off such that it is on half of the time (50% duty cycle) then the voltage seen by the U phase would be twelve volts. In the preferred embodiment, the PWM step is executed with new target voltages thirteen-thousand times per second. In the preferred embodiment, the PWM “chopping” is at the same frequency, although that is not required. The three chopped phase voltages cause current to flow across the current-sensing resistors (current-sensing step 910) and through the motor phase windings of the stator of the brushless DC motor 911.

The current-sensing step 910 in implementations may begin by sampling three sense resistors. The sense resistors may generate a very small voltage, and so an analog amplification network may be used to boost the gain to levels suitable for sampling by the micro-controller's analog-to-digital converter (ADC). The timing of current sense sampling may be selected to obtain proper low noise readings as is known in the art. One current value may be synthesized by knowledge of the other two through the application of Kirchhoff's voltage law. After acquisition by the micro-controller, the three current values may be sent to the Clarke transformation stage 909.

The Clarke transformation stage 909 takes the three phase current values and converts them into two orthogonal currents representing the stationary reference frame flux current and torque current, as is known in the art. These two currents are then forwarded to the Park transformation stage 908.

The Park transformation stage takes a stationary reference frame flux current and torque current and converts them to a rotating reference frame. This requires knowledge of the rotor's offset as measured between a rotor magnetic pole pair relative to a given motor pole, known as the rotor electrical angle, as is known in the art. In implementations the rotor electrical angle is supplied by the analog Hall sensors, although any other sensor capable of measuring an angular position may be used, such as an optical encoder, inductive encoder, and so forth, as is known in the art. The outputs of the Park transformation are the flux current and torque current values relative to the rotating frame of reference. These values are sent to the current control loop 904, where they close the feedback loop described herein. The properly calculated PWM motor phase currents cause the BLDC motor 911 to spin at the desired torque, jerk, acceleration, velocity, and position.

The analog Hall sensors 912 (which may be the same Hall sensors described previously) may be used to measure the rotor electrical angle and actual position of the motor shaft. In implementations there are two Hall sensors separated by ninety electrical degrees. Data from the two sensors is converted to a position within a pole pair using the inverse tangent (arctan 2) operation, as is known in the art. Other means of calculating electrical angle and rotor position may also be used, as is known in the art. For the actual position, transitions between pole pairs are noted, and the position is incremented appropriately to account for them.

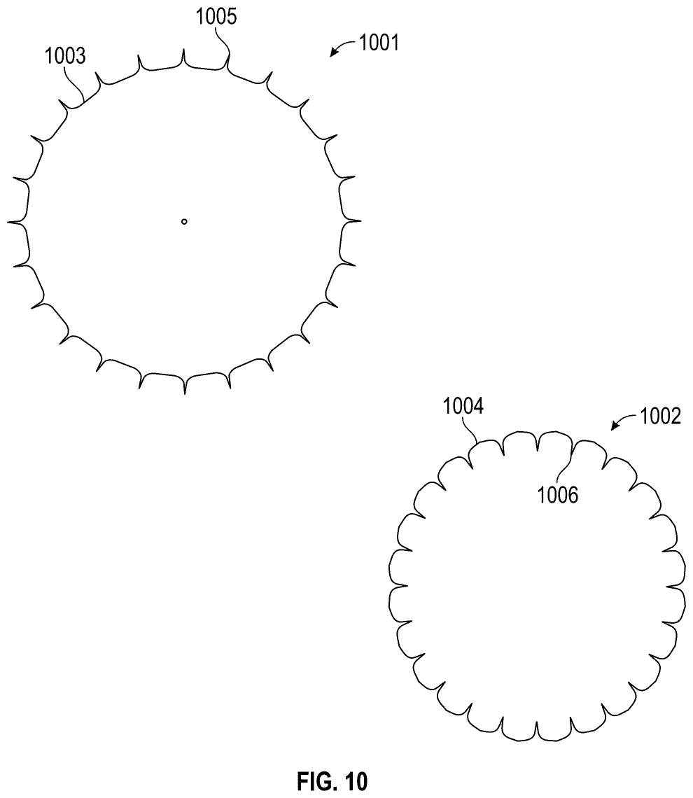

FIG. 10 representatively illustrates example anti-cogging elements of a motor. When rotating an unpowered motor by hand, the motor tends to seek to align the magnet poles with the stator slots such that varying torque is felt depending on position. This varying torque tends to be felt at multiples of the stator slots 1005 and rotor magnet poles, and is known as cogging torque. Motor construction techniques known in the art, such as skewed stator slots and skewed magnets can be used to compensate for cogging torque, but at added expense and with the penalty of reduced torque.

Cogging torque can make smooth low speed motion using a PID loop nearly impossible, as the loop cannot react with sufficient speed to overcome the non-linearity inherent in the cogging. Anti-cogging is a software technique to reduce cogging torque by building a model or map 1001 of the cogging torque imposed by the rotor at different angular positions and feeding a current (and therefore a torque) to the motor for each angular position according to a specification or configuration 1002 such that the feed-forward current cancels the cogging torque for each position. It can be seen how applying the current/torque according to the specification or configuration 1002 acts to neutralize the detected cogging torque illustrated by map 1001. Each peak 1005 that is detected (and is, accordingly, included in the model or map) is neutralized with a counter-peak 1006 in the specification or configuration 1002. The detected troughs 1003 are also echoed by counter-troughs 1004 in the specification or configuration.

Digital Hall sensors do not have sufficient resolution to implement a cogging position map, and so generally an external encoder must be used, at added expense. Additionally, a complex (and error-prone) calibration step must generally be initiated by the end user in order to benefit from anti-cogging capabilities.

By leveraging the high positional resolution of the integrated analog Hall sensing method, or through the use of an external encoder, a high quality cogging map may be built and stored in the motor's micro-controller memory at the time of production or manufacture/assembly, and without requiring a user-initiated calibration step. This allows the end user to benefit from smooth low-speed motion without added expense or complex calibration steps.

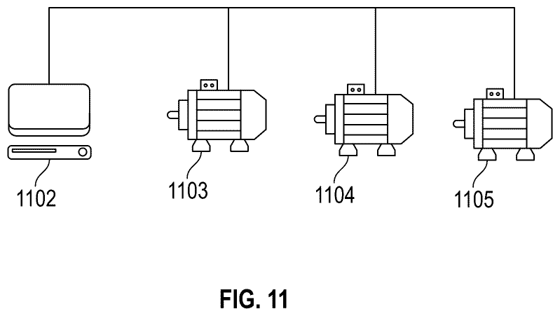

FIG. 11 representatively illustrates an example motor network. Motion control frequently requires coordinated movement of multiple motors. By using an RS-485 bus (or other shared communication bus known in the art, such as CAN or Ethernet, or even a wireless communication), the movement of multiple motors can be coordinated. Example motors 1103, 1104, 1105 may be set on different axes, and coordinated start times for the multiple axes may be initiated by using a broadcast command, sent by the computing device 1102 (which could be a host PC, a mobile device, or any other computing device). The start commands may be received and acted upon by multiple motors, on different axes, simultaneously. The motor network can thus initiate movement on multiple axes simultaneously (such as positional moves and/or velocity moves), query multiple axes simultaneously (such that the instantaneous position or velocity of multiple axes may be known to the host PC), and stop movement on multiple axes simultaneously (for example, if a limit is reached).

Virtual gearing may also be implemented, such that a movement ratio (“gear ratio”) between rotary axes, linear axes, or a combination of rotary and linear axes, is maintained. The movement may key off the goal position or the error position of the master axis, such that all axes stay synchronized in a manner that best suits the application.

More complex relationships such as circular motion, cam action, or wire unspooling, which are known in the art, may also be implemented using the motor network. Raw positional data may also be streamed to multiple axes simultaneously, such that the computing device 1102 can control movement at a fine level of detail, and without use of motor-based motion profile generation. This may be useful, for example, to allow the computing device to translate G-code data into movement data at the motors. This streamed data may be queued (stored in order) by the motors, and kept synchronized by maintaining a common clock time across multiple motors. This moves hard real-time requirements for timing from the computing device to the motors.

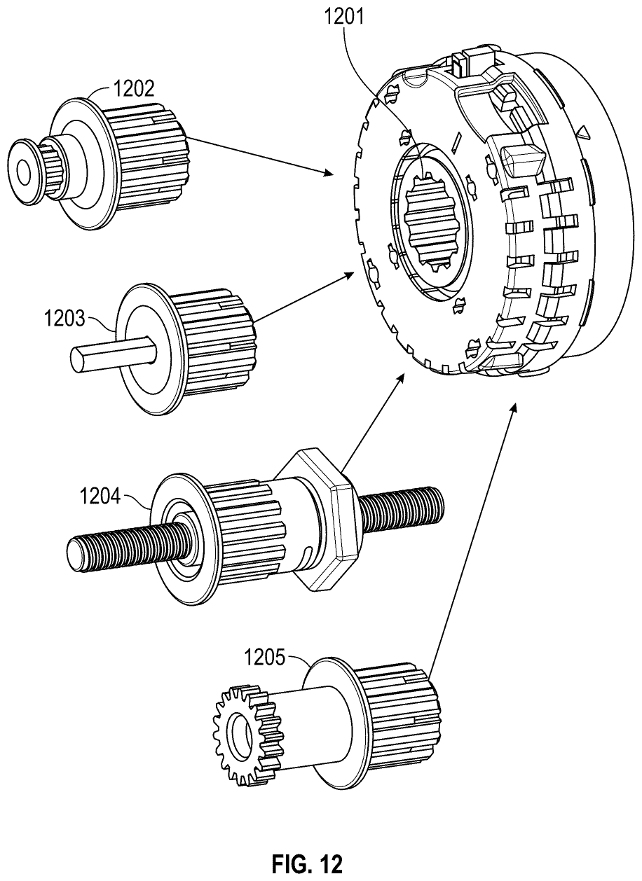

FIG. 12 shows a rear, side, exploded view of example elements of a motor. The axle of the motor has a through hole 1201 which may be used to route wires. A slip ring may be placed in or near the through hole to allow electrical signals to be routed to a rotating load while allowing unlimited rotation of the motor. Air or fluid may also be routed through the through hole, either by substantially sealing it with respect to the stationary portion of the motor, and/or by routing the air or fluid through tubes, said tubes optionally equipped with rotating couplers. This air or fluid may be used for cooling, heating, vacuum, or pneumatic or hydraulic control.

The central through-hole may also be designed to accept snap-in or threaded, nut-retained toothed pulleys 1202, axles 1203, and lead screw nuts 1204 of varying sizes, allowing a single motor to easily be customized by either the factory, a reseller, or the end user for use with different axle diameters, different lead screw pitches and diameters, and different uses and configurations. Custom inserts 1205 for particular applications (here a gear) may also be snapped in or retained with a nut. For example, adapters for use with servo horns, custom gears, custom pulleys, or custom bolt patterns may be designed and then three-dimensionally (3D) printed. Other methods of attaching a central axle or other adapter to the motor through-hole may also be used, such as bolts or screws, adhesives, or other attachment methods known in the art or hereafter discovered.

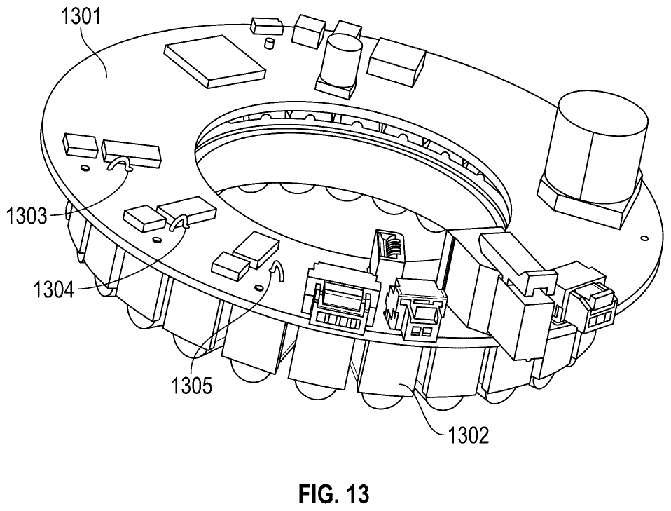

FIG. 13 representatively illustrates an example stator and PCB assembly of a motor. The stator wires may be directly bonded (soldered) to the PCB 1301 (which may be the same PCB as any of those described above) in order to simplify the assembly process and reduce the cost of production. The stator 1302 (which may be the same stator as any of those described above) has three phases and each phase has an input wire and an output wire. During the production process each of the three input wire leads and three output wire leads may be cut to a predetermined length and its insulation removed to a predetermined length. When wound using the Y-winding configuration, the outputs of each phase are all connected together. One or more through-holes in the PCB may be used to thread the wires through to the top face of the PCB, where they may easily be soldered together and covered with insulating material. In implementations the outputs of each phase are pulled through the one or more holes in the PCB and then bent back around and soldered onto one or more electrically floating (but electrically inter-connected) landings on the PCB, to facilitate attachment and eliminate the need for insulating the wire ends. By first leading the wire ends through a hole in the PCB, bending it, and then securing it to the PCB's top side, small variations in wire length can be accommodated because the hole allows wire movement. Additionally, the rigid nature of the motor magnet wire ensures that the bare wire ends above the hole stay in place once assembled, and do not touch any other electrically active components. Likewise, the start of each phase can be lead through a hole in the PCB, bent back around, and then attached (e.g., soldered) to one of multiple landings 1303, 1304, 1305 on the PCB that provide source and sink current to each phase. This also allows variations in wire length while securing the wire in a way that prevents it from shorting into other electrically active components. This technique eliminates the need for additional connectors or wiring to route power between the stator and the PCB.

In implementations the control electronics (such as the microcontroller and/or other implementing components used to implement the steps and elements of FIG. 9) also reside on the PCB, and are used to drive the motor and control its position and velocity over time. In implementations an STMICROELECTRONICS STSPIN32F0A or STSPIN32G4 three phase motor controller IC is used as the micro-controller and motor controller. Other micro-controllers and motor drive electronics, as known in the art, may also be used. Available reference designs such as the STMICROELECTRONICS EVALKIT-ROBOT-1 may be used as the basis for circuit design, firmware, and PCB layout. Analog Hall sensors may be sampled using an integrated or external ADC, and that value may be used as the input to the linearization scheme, discussed previously. In implementations a single microcontroller could include a motor controller and motor driver.

Implementations of motors disclosed herein are low-cost, fully integrated, FOC BLDC motors that include external communication and control, motion planning, motion control, and motor power stages. In implementations the motors use low cost polymer (such as plastic) in their design, and are fully integrated to minimize difficulty of use. In implementations a through-hole is included for simplified wiring and other uses such as venting air for vacuum or cooling, and support for various snap-in axles and lead-screws.

Any of the PCBs and PCB assemblies disclosed herein may include multiple components thereon, including a motor controller, a microcontroller, a motor driver, a magnetic rotational position sensor comprising Hall sensors, and so forth. Because the PCB is included/integrated within the motor itself, in implementations in which these components are included in/on the PCB they are, correspondingly, integrated within the motor.

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of motors and related methods of manufacture and use, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Additionally, in places where a claim below uses the term “first” as applied to an element, this does not imply that the claim requires a second (or more) of that element-if the claim does not explicitly recite a “second” of that element, the claim does not require a “second” of that element. Furthermore, in some cases a claim may recite a “second” or “third” or “fourth” (or so on) of an element, and this does not necessarily imply that the claim requires a first (or so on) of that element-if the claim does not explicitly recite a “first” (or so on) of that element (or an element with the same name, such as “a widget” and “a second widget”), then the claim does not require a “first” (or so on) of that element.

As used herein, the term “of” may refer to “coupled with.” For example, in some cases displays are referred to as a display “of” a first computer or computing device, a display “of” a second computer or computing device, and so forth. These terms are meant to be interpreted broadly so that a display “of” a computing device may be a separate display that is, either by wired or a wireless connection, communicatively coupled with the computing device.

The phrase “computing device” as used herein is meant to include any type of device having one or more processors and capable of communicating information using one or more integrated or communicatively-coupled displays, such as a personal computer, a laptop, a tablet, a mobile phone, a smart phone, a personal data assistant (PDA), smart glasses, a tablet, a smart watch, a smart speaker, a robot, any other human interaction device, and so forth.

It is pointed out that the provider of a software application, to be installed on end user computing devices (such as, by non-limiting example, mobile devices) at least partially facilitates an at least intermittent communicative coupling between one or more servers (which host or otherwise facilitate features of the software application) and the end user computing devices. This is so even if the one or more servers are owned and/or operated by a party other than the provider of the software application.

Method steps disclosed anywhere herein, including in the claims, may be performed in any feasible/possible order. Recitation of method steps in any given order in the claims or elsewhere does not imply that the steps must be performed in that order-such claims and descriptions are intended to cover the steps performed in any order except any orders which are technically impossible or not feasible. However, in some implementations method steps may be performed in the order(s) in which the steps are presented herein, including any order(s) presented in the claims.

What is claimed is:

1. A motor, comprising:
a stator comprising electrical windings thereon;
a stator housing at least partially housing the stator; and
a rotor assembly rotatingly coupled with the stator housing, the rotor assembly comprising:
a rotor formed of a polymer; and
a plurality of magnets coupled with the rotor.

2. The motor of claim 1, wherein the stator housing is formed of a polymer.

3. The motor of claim 1, wherein the magnets are arranged in a Halbach array.

4. The motor of claim 1, further comprising one of a motor controller, a motor driver, and a rotational position sensor disposed within the motor.

5. The motor of claim 1, further comprising a printed circuit board (PCB) disposed within the motor.

6. The motor of claim 5, wherein the PCB comprises one of a motor controller, a motor driver, and a rotational position sensor disposed thereon.

7. The motor of claim 1, further comprising a fan disposed at least partially within the stator housing and configured for directing airflow across surfaces of the stator.

8. The motor of claim 1, wherein the rotor includes slots and wherein the magnets are secured within the slots using one of a friction fit and a snap lock.

9. The motor of claim 1, wherein the rotor assembly does not include an adhesive.

10. The motor of claim 1, wherein the rotor assembly does not include a back-iron.

11. The motor of claim 1, further comprising an axle rotatingly coupled with the stator housing, wherein the motor comprises a through-hole configured for coupling detachable inserts therein.

12. A motor, comprising:
a stator comprising electrical windings thereon;
a stator housing at least partially housing the stator;
a rotor assembly rotatingly coupled with the stator housing, the rotor assembly comprising a rotor and a plurality of magnets coupled with the rotor; and
a printed circuit board (PCB) assembly comprising one or more electrical components including one of a motor controller, a motor driver, and a rotational position sensor disposed thereon;
wherein at least a portion of the electrical windings pass through one or more through holes in the PCB to electrically couple with the one or more electrical components.

13. The motor of claim 12, wherein the PCB is at least partially housed within the stator housing.

14. A method of manufacture of a rotor for a motor, comprising:
positioning a rotor and one or more magnet inserters of a machine at one or more alignment positions relative to one another so that one or more slots of the rotor are aligned with the one or more magnet inserters; and
using the one or more magnet inserters, automatically inserting a plurality of magnets into the one or more slots in a manner such that the plurality of magnets, once inserted, are oriented relative to one another such that they form a Halbach array.

15. The method of claim 14, wherein the one or more magnet inserters comprises one or more linear plungers.

16. The method of claim 14, wherein the machine includes one or more rotators and further includes one or more cartridges for holding the plurality of magnets prior to insertion, and wherein the method further comprises, using the one or more rotators, rotating the one or more cartridges relative to one or more axes of motion of the one or more magnet inserters.

17. The method of claim 16, wherein the method comprises, using the one or more rotators, rotating the one or more cartridges ninety degrees relative to the one or more axes of motion of the one or more magnet inserters.

18. The method of claim 14, wherein each of the magnets comprises a square cross section orthogonal to a direction of motion of the one or more magnet inserters.

19. The method of claim 14, wherein the magnets are secured into the slots using a friction fit.

20. The method of claim 14, wherein the magnets are secured into the slots using a plurality of snap locks.
